(19) United States
(12) Patent Application Publication
(10) Pub. No.: US 2015/0236829 A1
(43) Pub. Date: Aug. 20, 2015

(54) METHOD, APPARATUS, SYSTEM AND COMPUTER PROGRAM PRODUCT FOR COORDINATION OF WIRELESS TRANSMISSION IN A FREQUENCY BAND

(71) Applicants: Rapeepat Ratasuk, Hoffman Estates, IL (US); Nitin Mangalvedhe, Hoffman Estates, IL (US); Mikko Aleksi Uusitalo, Helsinki (FI); Sassan Iraji, Espoo (FI); Antti Sorri, Helsinki (FI)

(72) Inventors: Rapeepat Ratasuk, Hoffman Estates, IL (US); Nitin Mangalvedhe, Hoffman Estates, IL (US); Mikko Aleksi Uusitalo, Helsinki (FI); Sassan Iraji, Espoo (FI); Antti Sorri, Helsinki (FI)

(73) Assignee: NOKIA SOLUTIONS AND NETWORKS OY, Espoo (FI)

(21) Appl. No.: 14/424,563

(22) PCT Filed: Aug. 31, 2012
(86) PCT No.: PCT/US12/53410

§ 371 Date: Apr. 10, 2015

(51) Int. Cl. H04L 5/00; H04W 74/04; H04W 72/04

(52) U.S. Cl. CPC H04L 5/0048; H04W 72/0453; H04W 74/04

(57) ABSTRACT

A method and apparatus can be configured to perform steps comprising receiving channel-state information of at least one channel in a frequency band from at least a subset of a plurality of transmission nodes. The method may further comprise coordinating reserving of the at least one channel for a set of transmission nodes within the plurality of transmission nodes. The coordinating may be based on the received channel-state information to allow simultaneous transmission on the at least one channel by the set of transmission nodes. The method may further comprise communicating reservation information for the at least one channel to the set of transmission nodes.

### BACKGROUND

1. Field

Embodiments of the invention relate to wireless transmission technology deployment in frequency bands, such as, but not limited to, for example, methods of coordinating Long Term Evolution (LTE) evolved Node Bs (eNBs) to allow them to transmit using a same time-frequency resource.

2. Description of the Related Art

LTE is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE has seen extensive deployment in a wide variety of contexts involving the communication of data.

### SUMMARY

According to a first embodiment, a method may comprise receiving channel-state information of at least one channel in a frequency band from at least a subset of a plurality of transmission nodes. The method may also comprise coordinating reserving of the at least one channel for a set of transmission nodes within the plurality of transmission nodes. The coordinating may be based on the received channel-state information to allow simultaneous transmission on the at least one channel by the set of transmission nodes. The method may also comprise communicating reservation information for the at least one channel to the set of transmission nodes.

In the method of the first embodiment, the method may further comprise determining the set of transmission nodes for temporarily reserving the at least one channel. The set may be determined based on the received channel-state information.

In the method of the first embodiment, the method may be performed by a controller.

In the method of the first embodiment, the plurality of transmission nodes may comprise a plurality of long-term evolution nodes.

In the method of the first embodiment, the set of transmission nodes may be isolated from other transmission nodes of the plurality of transmission nodes.

In the method of the first embodiment, the frequency band may be an unlicensed band.

In the method of the first embodiment, the transmission nodes of the plurality of transmission nodes may be geographically clustered.

In the method of the first embodiment, the reservation information may comprise at least one of a start time and a length of time for reserving of the channel.

In the method of the first embodiment, the method may further comprise polling the channel-state information of the at least one channel from the subset of the plurality of transmission nodes.

According to a second embodiment, an apparatus may comprise receiving means for receiving channel-state information of at least one channel in a frequency band from at least a subset of a plurality of transmission nodes. The apparatus may also comprise coordinating means for coordinating reserving of the at least one channel for a set of transmission nodes within the plurality of transmission nodes. The coordinating may be based on the received channel-state information to allow simultaneous transmission on the at least one channel by the set of transmission nodes. The apparatus may also comprise communicating means for communicating reservation information for the at least one channel to the set of transmission nodes.

In the apparatus of the second embodiment, the apparatus may further comprise determining means for determining the set of transmission nodes for temporarily reserving the at least one channel. The set may be determined based on the received channel-state information.

In the apparatus of the second embodiment, the apparatus may be a controller.

In the apparatus of the second embodiment, the plurality of transmission nodes may comprise a plurality of long-term evolution nodes.

In the apparatus of the second embodiment, the set of transmitting nodes may be isolated from other transmitting nodes of the plurality of transmitting nodes.

In the apparatus of the second embodiment, the frequency band may be an unlicensed band.

In the apparatus of the second embodiment, the transmission nodes of the plurality of transmission nodes may be geographically clustered.

In the apparatus of the second embodiment, the reservation information may comprise at least one of a start time and a length of time for reserving of the channel.

In the apparatus of the second embodiment, the apparatus may further comprise polling means for polling the channel-state information of the at least one channel from the subset of the plurality of transmission nodes.

According to a third embodiment, a method may comprise receiving, by a transmission node, reservation information for at least one channel in a frequency band from a second node. The method may also comprise determining, by the transmission node, a temporary time for reserving the at least one channel based on the received reservation information. The method may also comprise reserving the at least one channel for the determined temporary time.

In the method of the third embodiment, the method may further comprise detecting, by the transmission node, channel-state information of the at least one channel, and providing, by the transmission node, the detected channel-state information to the second node.

In the method of the third embodiment, the method may further comprise determining, by the transmission node, whether other transmission nodes have started transmitting via the at least one channel. If other transmission nodes have started transmitting, the temporary time may be affected by the transmissions of the other transmission nodes.

In the method of the third embodiment, the method may further comprise determining, by the transmission node, whether the at least one channel is free from non-long-term evolution communication. The transmission node may comprise a long-term evolution transmission node.

In the method of the third embodiment, the method may further comprise issuing, by the transmission node, a request-to-send/clear-to-send reservation command for reserving the at least one channel.

In the method of the third embodiment, the frequency band may be an unlicensed band.

In the method of the third embodiment, the transmission node may be one of a plurality of transmission nodes which are geographically clustered.

In the method of the third embodiment, the received reservation information may comprise at least one of a start time and a length of time for reserving the channel.

In the method of the third embodiment, the providing may be performed after the transmission node receives a polling request from the second node.

In the method of the third embodiment, the reserving of the at least one channel may start only when the detected channel-state information indicates that the channel is free.

According to a fourth embodiment, an apparatus may comprise receiving means for receiving reservation information for at least one channel in a frequency band from a second apparatus. The apparatus may also comprise first determining means for determining a temporary time for reserving the at least one channel based on the received reservation information. The apparatus may also comprise reserving means for reserving the at least one channel for the determined temporary time.

In the apparatus of the fourth embodiment, the apparatus may also comprise detecting means for detecting channel-state information of the at least one channel. The apparatus may also comprise providing means for providing the detected channel-state information to the second apparatus.

In the apparatus of the fourth embodiment, the apparatus may also comprise second determining means for determining whether other apparatuses have started transmitting via the at least one channel. If the other apparatuses have started transmitting, the temporary time may be affected by the transmission of the other apparatuses.

In the apparatus of the fourth embodiment, the apparatus may also comprise third determining means for determining whether the at least one channel is free from non-long-term evolution communication. The apparatus may also comprise a long-term evolution transmission node.

In the apparatus of the fourth embodiment, the apparatus may also comprise issuing means for issuing a request-to-send/clear-to-send reservation command for reserving the at least one channel.

In the apparatus of the fourth embodiment, the frequency band may be an unlicensed band.

In the apparatus of the fourth embodiment, the apparatus may be one of a plurality of apparatuses which are geographically clustered.

In the apparatus of the fourth embodiment, the received reservation information may comprise at least one of a start time and a length of time for reserving the channel.

In the apparatus of the fourth embodiment, the providing may be performed after the transmission node receives a polling request from the second apparatus.

In the apparatus of the fourth embodiment, the reserving of the at least one channel may start only when the detected channel-state information indicates that the channel is free.

In the apparatus of the fourth embodiment, wherein the apparatus may be a base station.

According to a fifth embodiment, a method may comprise exchanging, by a first transmission node, information with at least one other transmission node. The information may comprise reservation related information for at least one channel in a frequency band. The method may also comprise agreeing, with the at least one other transmission node, on a temporary reservation time for the at least one channel. The method may also comprise reserving, by the first transmission node, the at least one channel for the agreed temporary reservation time.

In the method of the fifth embodiment, the frequency band may be an unlicensed band.

In the method of the fifth embodiment, the first transmission node may be one of a plurality of transmission nodes which are geographically clustered.

In the method of the fifth embodiment, the information may comprise channel-state information of the channel.

In the method of the fifth embodiment, the exchanged reservation information may comprise at least one of a start time and a length of time for reserving the at least one channel.

In the method of the fifth embodiment, the agreed temporary reservation time may comprise at least one of a start time and a length of time for reserving the at least one channel.

In the method of the fifth embodiment, the method may further comprise detecting channel-state information of the channel. The reserving of the at least one channel may start only when the detected channel-state information indicates that the at least one channel is free.

According to a sixth embodiment, an apparatus may comprise exchanging means for exchanging information with at least one other apparatus. The information may comprise reservation related information for at least one channel in a frequency band. The apparatus may also comprise agreeing means for agreeing, with the at least one other apparatus, on a temporary reservation time for the at least one channel. The apparatus may also comprise reserving means for reserving the at least one channel for the agreed temporary reservation time.

In the apparatus of the sixth embodiment, the frequency band may be an unlicensed band.

In the apparatus of the sixth embodiment, the apparatus may be one of a plurality of apparatuses which are geographically clustered.

In the apparatus of the sixth embodiment, the information may comprise channel-state information of the at least one channel.

In the apparatus of the sixth embodiment, the exchanged reservation information may comprise at least one of a start time and a length of time for reserving the at least one channel.

In the apparatus of the sixth embodiment, the agreed temporary reservation time may comprise at least one of a start time and a length of time for reserving the at least one channel.

In the apparatus of the sixth embodiment, the apparatus may also comprise detecting means for detecting channel-state information of the at least one channel. The reserving of the at least one channel may start only when the detected channel-state information indicates that the at least one channel is free.

In the apparatus of the sixth embodiment, wherein the apparatus may be a base station.

According to a seventh embodiment, a method may comprise detecting, by a first transmission node, whether a second transmission node has issued a reservation command reserving at least one channel in a frequency band. The method may also comprise reserving simultaneously the at least one channel by the first transmission node.

In the method of the seventh embodiment, the reserving simultaneously may comprise reserving simultaneously the at least one channel if the transmission technologies of the first and second transmission node are similar.

In the method of the seventh embodiment, the frequency band may be an unlicensed band.

In the method of the seventh embodiment, the reservation command may comprise at least one of an indication of the used transmission technology and an ending time for a reservation period.

In the method of the seventh embodiment, the indication of the used transmission technology may comprise an access point identification.

In the method of the seventh embodiment, the used transmission technology may be long-term evolution.

In the method of the seventh embodiment, the method may further comprise determining, by the first transmission node, a length of time for reserving the at least one channel.

In the method of the seventh embodiment, the length of time for reserving the at least one channel may be determined in such a way, that a temporary reservation period of the at least one channel ends at the same time point as for the second transmission node.

According to an eighth embodiment, an apparatus may comprise detecting means for detecting whether a second apparatus has issued a reservation command reserving at least one channel in a frequency band. The apparatus may also comprise reserving means for reserving simultaneously the at least one channel.

In the apparatus of the eighth embodiment, the reserving means may reserve simultaneously the at least one channel if the transmission technologies of the apparatus and the second apparatus are similar.

In the apparatus of the eighth embodiment, the frequency band may be an unlicensed band.

In the apparatus of the eighth embodiment, the reservation command may comprise at least one of an indication of the used transmission technology and an ending time for a reservation period.

In the apparatus of the eighth embodiment, the indication of the used transmission technology may comprise an access point identification.

In the apparatus of the eighth embodiment, the used transmission technology may be long-term evolution.

In the apparatus of the eighth embodiment, the apparatus may further comprise determining means for determining a length of time for reserving the at least one channel.

In the apparatus of the eighth embodiment, the length of time for reserving the at least one channel may be determined in such a way, that a temporary reservation period of the at least one channel ends at the same time point as for the second apparatus.

In the apparatus of the eighth embodiment, the apparatus may be a base station.

According to a ninth embodiment, a system may comprise a first apparatus. The first apparatus may comprise receiving means for receiving channel-state information of at least one channel in a frequency band from at least a subset of a plurality of transmission nodes. The first apparatus may also comprise coordinating means for coordinating reserving of the at least one channel for a set of transmission nodes within the plurality of transmission nodes. The coordinating may be based on the received channel-state information to allow simultaneous transmission on the at least one channel by the set of transmission nodes. The first apparatus may also comprise communicating means for communicating reservation information for the at least one channel to the set of transmission nodes. The system may also comprise a second apparatus. The second apparatus may comprise receiving means for receiving reservation information for at least one channel in a frequency band from the first apparatus. The second apparatus may also comprise first determining means for determining a temporary time for reserving the at least one channel based on the received reservation information. The second apparatus may also comprise reserving means for reserving the at least one channel for the determined temporary time.

According to a tenth embodiment, a computer program product may comprise code for executing the methods according to any of the first, third, fifth, and seventh embodiments.

In the computer program product of the tenth embodiment, the computer program product may be a computer program comprising a computer-readable medium bearing computer program code embodied therein for use with a computer.

According to an eleventh embodiment, a system may comprise a first apparatus. The first apparatus may comprise exchanging means for exchanging information with at least one other apparatus. The information may comprise reservation related information for at least one channel in a frequency band. The first apparatus may also comprise agreeing means for agreeing, with the at least one other apparatus, on a temporary reservation time for the at least one channel. The first apparatus may also comprise reserving means for reserving the at least one channel for the agreed temporary reservation time. The system may also comprise a second apparatus. The second apparatus may comprise exchanging means for exchanging information with the first apparatus. The information may comprise reservation related information for at least one channel in a frequency band. The second apparatus may also comprise agreeing means for agreeing, with the first apparatus, on a temporary reservation time for the at least one channel. The second apparatus may also comprise reserving means for reserving the at least one channel for the agreed temporary reservation time.

According to a twelfth embodiment, a system may comprise a first apparatus. The first apparatus may comprise detecting means for detecting whether at least one other apparatus has issued a reservation command reserving at least one channel in a frequency band. The first apparatus may also comprise reserving means for reserving simultaneously the at least one channel. The system may also comprise a second apparatus. The second apparatus may comprise detecting means for detecting whether the first apparatus has issued a reservation command reserving at least one channel in a frequency band. The second apparatus may also comprise reserving means for reserving simultaneously the at least one channel.

According to a thirteenth embodiment, an apparatus may comprise at least one processor and at least one memory comprising computer program code. The at least one memory and the computer program code may be configured to, with the at least one processor, cause the apparatus at least to receive channel-state information of at least one channel in a frequency band from at least a subset of a plurality of transmission nodes. The apparatus may also coordinate reserving of the at least one channel for a set of transmission nodes within the plurality of transmission nodes. The coordinating may be based on the received channel-state information to allow simultaneous transmission on the at least one channel by the set of transmission nodes. The apparatus may also communicate reservation information for the at least one channel to the set of transmission nodes.

In the apparatus of the thirteenth embodiment, the apparatus may also determine the set of transmission nodes for temporarily reserving the at least one channel. The set may be determined based on the received channel-state information.

In the apparatus of the thirteenth embodiment, the apparatus may be a controller.

In the apparatus of the thirteenth embodiment, the plurality of transmission nodes may comprise a plurality of long-term evolution nodes.

In the apparatus of the thirteenth embodiment, the set of transmission nodes may be isolated from other transmission nodes of the plurality of transmission nodes.

In the apparatus of the thirteenth embodiment, the frequency band may be an unlicensed band.

In the apparatus of the thirteenth embodiment, the transmission nodes of the plurality of transmission nodes may be geographically clustered.

In the apparatus of the thirteenth embodiment, the reservation information may comprise at least one of a start time and a length of time for reserving of the channel.

In the apparatus of the thirteenth embodiment, the apparatus may also poll the channel-state information of the at least one channel from the subset of the plurality of transmission nodes.

According to a fourteenth embodiment, an apparatus may comprise at least one processor and at least one memory comprising computer program code. The at least one memory and the computer program code may be configured to, with the at least one processor, cause the apparatus at least to receive, by a transmission node, reservation information for at least one channel in a frequency band from a second node. The apparatus may also determine, by the transmission node, a temporary time for reserving the at least one channel based on the received reservation information. The apparatus may also reserve the at least one channel for the determined temporary time.

In the apparatus of the fourteenth embodiment, the apparatus may also detect, by the transmission node, channel-state information of the at least one channel, and provide, by the transmission node, the detected channel-state information to the second node.

In the apparatus of the fourteenth embodiment, the apparatus may also determine, by the transmission node, whether other transmission nodes have started transmitting via the at least one channel. If other transmission nodes have started transmitting, the temporary time may be affected by the transmissions of the other transmission nodes.

In the apparatus of the fourteenth embodiment, the apparatus may also determine, by the transmission node, whether the at least one channel is free from non-long-term evolution communication. The transmission node may comprise a long-term evolution transmission node.

In the apparatus of the fourteenth embodiment, the apparatus may also issue, by the transmission node, a request-to-send/clear-to-send reservation command for reserving the at least one channel.

In the apparatus of the fourteenth embodiment, the frequency band may be an unlicensed band.

In the apparatus of the fourteenth embodiment, the transmission node may be one of a plurality of transmission nodes which are geographically clustered.

In the apparatus of the fourteenth embodiment, the received reservation information may comprise at least one of a start time and a length of time for reserving the channel.

In the apparatus of the fourteenth embodiment, the providing may be performed after the transmission node receives a polling request from the second node.

In the apparatus of the fourteenth embodiment, the reserving of the at least one channel may start only when the detected channel-state information indicates that the channel is free.

According to a fifteenth embodiment, an apparatus may comprise at least one processor and at least one memory comprising computer program code. The at least one memory and the computer program code may be configured to, with the at least one processor, cause the apparatus at least to exchange, by a first transmission node, information with at least one other transmission node. The information may comprise reservation related information for at least one channel in a frequency band. The apparatus may also agree, with the at least one other transmission node, on a temporary reservation time for the at least one channel. The apparatus may also reserve, by the first transmission node, the at least one channel for the agreed temporary reservation time.

In the apparatus of the fifteenth embodiment, the frequency band may be an unlicensed band.

In the apparatus of the fifteenth embodiment, the first transmission node may be one of a plurality of transmission nodes which are geographically clustered.

In the apparatus of the fifteenth embodiment, the information may comprise channel-state information of the channel.

In the apparatus of the fifteenth embodiment, the exchanged reservation information may comprise at least one of a start time and a length of time for reserving the at least one channel.

In the apparatus of the fifteenth embodiment, the agreed temporary reservation time may comprise at least one of a start time and a length of time for reserving the at least one channel.

In the apparatus of the fifteenth embodiment, the apparatus may also detect channel-state information of the channel. The reserving of the at least one channel may start only when the detected channel-state information indicates that the at least one channel is free.

According to a sixteenth embodiment, an apparatus may comprise at least one processor and at least one memory comprising computer program code. The at least one memory and the computer program code may be configured to, with the at least one processor, cause the apparatus at least to detect, by a first transmission node, whether a second transmission node has issued a reservation command reserving at least one channel in a frequency band. The apparatus may also reserve simultaneously the at least one channel by the first transmission node.

In the apparatus of the sixteenth embodiment, the reserving simultaneously may comprise reserving simultaneously the at least one channel if the transmission technologies of the first and second transmission node are similar.

In the apparatus of the sixteenth embodiment, the frequency band may be an unlicensed band.

In the apparatus of the sixteenth embodiment, the reservation command may comprise at least one of an indication of the used transmission technology and an ending time for a reservation period.

In the apparatus of the sixteenth embodiment, the indication of the used transmission technology may comprise an access point identification.

In the apparatus of the sixteenth embodiment, the used transmission technology may be long-term evolution.

In the apparatus of the sixteenth embodiment, the apparatus may also determine, by the first transmission node, a length of time for reserving the at least one channel.

In the apparatus of the sixteenth embodiment, the length of time for reserving the at least one channel may be determined in such a way, that a temporary reservation period of the at least one channel ends at the same time point as for the second transmission node.

According to a seventeenth embodiment, a system may comprise a first apparatus. The first apparatus may comprise at least one processor and at least one memory comprising computer program code. The at least one memory and the computer program code may be configured to, with the at least one processor, cause the apparatus at least to receive channel-state information of at least one channel in a frequency band from at least a subset of a plurality of transmission nodes. The first apparatus may also coordinate reserving of the at least one channel for a set of transmission nodes within the plurality of transmission nodes. The coordinating may be based on the received channel-state information to allow simultaneous transmission on the at least one channel by the set of transmission nodes. The first apparatus may also communicate reservation information for the at least one channel to the set of transmission nodes. The system may also comprise a second apparatus. The second apparatus may comprise at least one processor and at least one memory comprising computer program code. The at least one memory and the computer program code may be configured to, with the at least one processor, cause the second apparatus at least to receive reservation information for at least one channel in a frequency band from the first apparatus. The second apparatus may also determine a temporary time for reserving the at least one channel based on the received reservation information. The second apparatus may also reserve the at least one channel for the determined temporary time.

According to an eighteenth embodiment, a system may comprise a first apparatus. The first apparatus may comprise at least one processor and at least one memory comprising computer program code. The at least one memory and the computer program code may be configured to, with the at least one processor, cause the first apparatus at least to exchange information with at least one other apparatus. The information may comprise reservation related information for at least one channel in a frequency band. The first apparatus may also agree, with the at least one other apparatus, on a temporary reservation time for the at least one channel. The first apparatus may also reserve the at least one channel for the agreed temporary reservation time. The system may also comprise a second apparatus. The second apparatus may comprise at least one processor and at least one memory comprising computer program code. The at least one memory and the computer program code may be configured to, with the at least one processor, cause the second apparatus at least to exchange information with the first apparatus. The information may comprise reservation related information for at least one channel in a frequency band. The second apparatus may also agree, with the first apparatus, on a temporary reservation time for the at least one channel. The apparatus may also reserve, by the first transmission node, the at least one channel for the agreed temporary reservation time.

According to a nineteenth embodiment, a system may comprise a first apparatus. The first apparatus may comprise at least one processor and at least one memory comprising computer program code. The at least one memory and the computer program code may be configured to, with the at least one processor, cause the first apparatus at least to detect whether at least one other apparatus has issued a reservation command reserving at least one channel in a frequency band. The first apparatus may also reserve simultaneously the at least one channel. The system may also comprise a second apparatus. The second apparatus may comprise at least one processor and at least one memory comprising computer program code. The at least one memory and the computer program code may be configured to, with the at least one processor, cause the second apparatus at least to detect whether the first apparatus has issued a reservation command reserving at least one channel in a frequency band. The second apparatus may also reserve simultaneously the at least one channel.

### BRIEF DESCRIPTION OF THE DRAWINGS

For proper understanding of the invention, reference should be made to the accompanying drawings, wherein:

FIG. 1 illustrates, according to one embodiment, LTE deployment in a cluster.

FIG. 2 illustrates the operation, according to one embodiment, of LTE deployment in an unlicensed band to support carrier aggregation.

FIG. 3 illustrates, according to one embodiment, channel reservation via a centralized entity.

FIG. 4 illustrates, according to one embodiment, distributed channel reservation based on over-the-air RTS/CTS observation.

FIG. 5 illustrates, according to one embodiment, LTE throughput in an unlicensed band.

FIG. 6 illustrates a flow diagram of a method according to one embodiment;

FIG. 7 illustrates an apparatus according to one embodiment;

FIG. 8 illustrates a system of apparatuses according to one embodiment;

FIG. 9 illustrates another system of apparatuses according to one embodiment;

FIG. 10 illustrates another system of apparatuses according to one embodiment;

### DETAILED DESCRIPTION

Embodiments of the invention include methods of coordination among transmitting nodes, such as, for example, evolved Node Bs (eNBs) in Long-term Evolution (LTE), in order to allow the transmitting nodes to transmit data using a same time-frequency resource in a frequency band, for example, an unlicensed band or a band with coexisting technologies (like, for example, TV white spaces). The transmitting nodes may be nodes used in any type of radio access technology.

One type of frequency band is a lightly-licensed band. With a lightly-licensed band, operators may be required to register with the Federal Communications Commission in order to use this band, but the operators generally do not need to purchase a license (nor do they need to purchase/register their use in exchange for any nominal fee). Multiple operators in a same region may share a spectrum of such a band.

Another type of frequency band is a license-exempt or unlicensed band. With a license-exempt band, operators may operate without a license but may be required to use certified equipment and comply with coexisting requirements. Operators may not have exclusive use of a spectrum of such a band.

Another type of frequency band use is secondary usage of the licensed band. Such usage is temporary usage of a licensed spectrum by a secondary user. For example, a public safety entity may own a spectrum and allow commercial operators to use it when free, but will reclaim the spectrum as needed.

TV white space is spectrum allocated to TV broadcasting, but may not be used locally for that purpose, being therefore available for other use. There can be other types of white spaces as well, reserved for a certain purpose, but not used in a certain location over a particular time period.

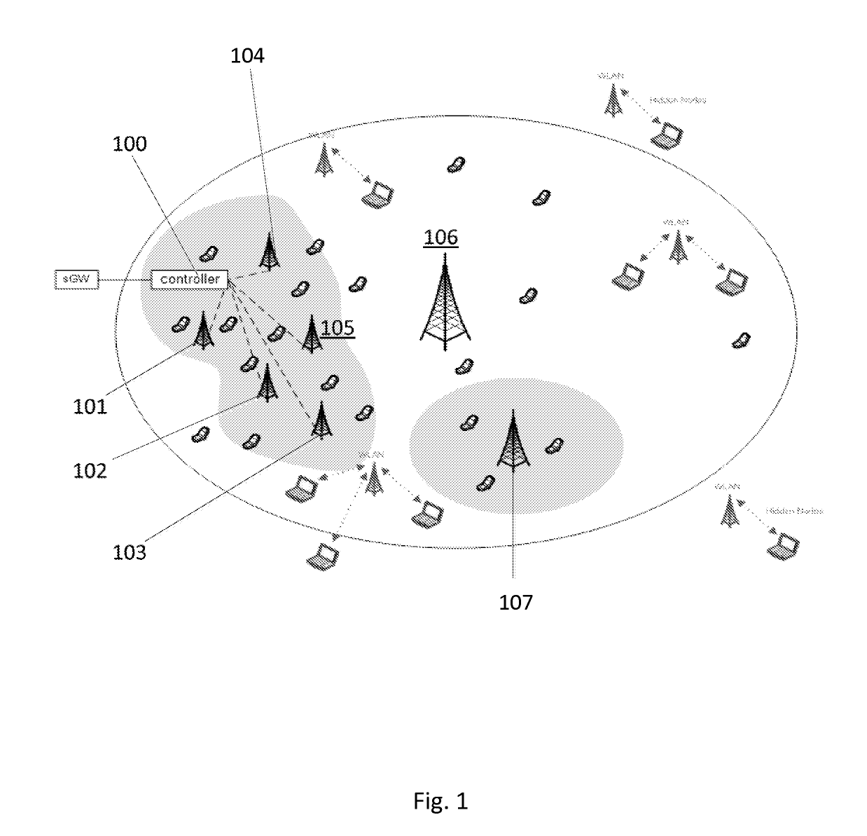

When, for example, an LTE eNB, deployed within a frequency band, is isolated from or sufficiently far away from other LTE eNBs, Media Access Control (MAC) mechanisms such as listen-before-talk mechanisms operate well when coordinating the transmission of the isolated LTE eNB. However, as illustrated in FIG. 1, instead of being isolated, the LTE eNB 101 may be deployed as, for example, a part of a cluster (101-105) in order to contend with capacity constraint in hotspots, shopping malls, airports, etc. There may also be other eNBs (106 and 107) outside of the cluster. If the LTE eNB 101 is deployed as a part of a cluster (101-105) and begins transmission, as shown in FIG. 1, transmission from the LTE eNB 101 may be detected by several other non-transmitting LTE eNBs. If a listen-before-talk mechanism is strictly adhered to by the non-transmitting eNBs, then the non-transmitting LTE eNBs will remain silent (i.e., not transmit data) while the transmitting LTE eNB 101 transmits.

However, rather than remaining silent, the non-transmitting eNBs, if they have pending data to send, may transmit at the same time as the transmitting eNB 101. By enabling the non-transmitting eNBs to transmit at the same time as the transmitting eNB 101, the LTE network may increase the capacity of data transmission without any substantial negative effects because LTE is tolerant to interference among transmitting eNBs. LTE is tolerant to interference because LTE, at least, uses fast power control, link adaptation comprising, for example, adaptive modulation and coding, physical-layer Hybrid Automatic Repeat Request (HARQ), and channel state feedback. In fact, LTE networks are normally deployed using a frequency reuse factor of one (i.e., all eNBs use the same frequency) because this configuration may provide the best performance.

Therefore, among, for example, LTE eNBs deployed in a frequency band (for example, an unlicensed band), simultaneous transmission by the eNBs may be enabled. Simultaneous transmissions may be transmissions which, at some point in time, occur at the same time. Although simultaneous transmissions may comprise transmissions whose respective durations overlap for a period of time, the start time and end time of each transmission do not necessarily coincide with the start time and end time of another transmission. In order to enable simultaneous transmission, some coordination may be required among the LTE eNBs as to when a channel is available for use and as to the need to reserve the channel for exclusive use by the eNBs. Such coordination may be provided in a centralized or distributed manner. If eNBs are a part of a same cluster, but are far enough that they do not hear each other, such coordination may not be needed.

In one embodiment that provides coordination in a centralized manner, as illustrated in FIG. 1, a centralized entity such as a controller 100 may serve as a data gateway for all the LTE eNBs 101-105 (for example, all eNBs within a cluster) and thus can be used to coordinate transmission by the eNBs in the frequency band.

According to this embodiment, each eNB senses the channel and forwards channel-state information/statistics about the channel's state to the controller 100. Alternatively, the controller 100 may poll the eNBs and request channel-state information/statistics about the channel's state from the eNBs. Channel-state information may comprise information that indicates whether the channel is busy or free from transmissions as determined by sensing performed by transmitting nodes. Channel-state information may also indicate an amount of noise/interference on the channel, the users of a channel, the number of users attached to the eNB, and the power level of the channel. The controller 100 may then determine reservation details for the channel (for example when to reserve the channel and for how long to reserve the channel). The controller 100 may also determine which eNBs will have transmissions coordinated by the controller 100.

First, the controller 100 may, for example, determine how long to reserve the channel based on a fairness mechanism that accounts for other systems that are also using the channel (e.g., a WiFi system). Next, the controller 100 may determine when channel reservation can begin. The controller 100 may determine when channel reservation begins according to, at least, two methods as described in further detail below.

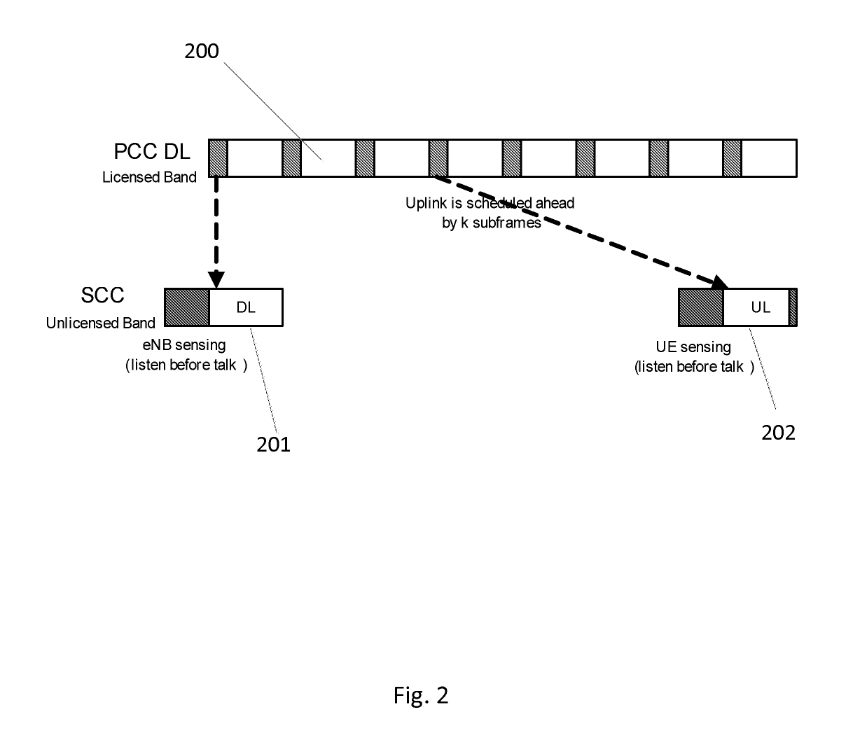

Deployment of LTE eNBs within an unlicensed band may support carrier aggregation. As illustrated in FIG. 2, in one embodiment, primary downlink/uplink (DL/UL) carriers may be on a licensed band 200 while secondary carriers (SCC) may be on unlicensed bands (201, 202). All control information may be carried on the primary DL/UL carriers (PCC), while the SCC may carry data whenever SCC is available. In such a case, the SCCs may be treated as extension carriers to the primary carriers.

In order to employ LTE in an unlicensed band, a fairness media access control (MAC) mechanism may be introduced. Examples of fairness MAC mechanisms are “listen-before-talk” mechanisms and “Request-to-Send/Clear-to-Send” (RTS/CTS) mechanisms.

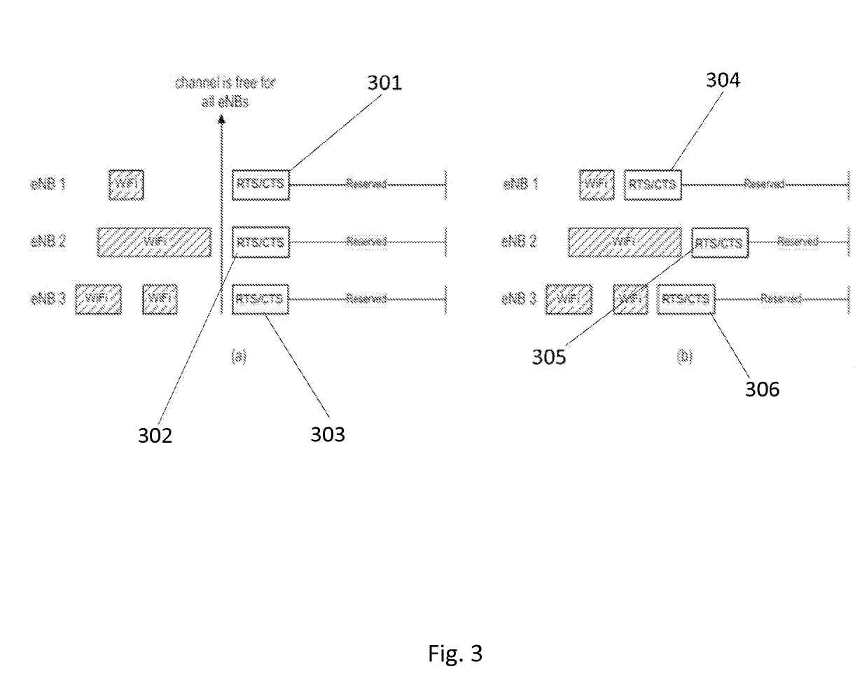

As described above, a controller may determine when channel reservation begins according to, at least, two methods. In a first method, the controller may poll eNBs to determine when the channel is free from non-LTE transmission, and then issue the reservation request when the channel is free. As illustrated in FIG. 3(a), in one embodiment, each eNB (i.e., eNB 1, eNB 2, and eNB 3) periodically monitors the channel and transmits the observed channel state to the controller. Once all eNBs observe that the channel is free, the controller may instruct each eNB to issue, for example, an RTS/CTS command (301, 302, and 303) to reserve the channel. In certain embodiments, the eNBs may each reserve the same channel. Within the reserved time, all eNBs are free to transmit data. In another embodiment, the controller may instruct the eNBs to reserve the channel when a majority of the eNBs report that the channel is free. The controller may then decide the subset of eNBs that will issue the reservation command. For example, the coordinating entity may determine a subset of eNBs that are isolated from other eNBs (and the subset may therefore operate independently) based on received channel state feedback. The subset of eNBs, that may operate independently, may then be instructed to reserve the channel.

The controller may also use a second, alternative method to coordinate the eNBs. In the second method, the controller may decide a starting time (e.g., an “LTE Transmission Period”) and/or a length of channel reservation and each eNB may reserve the channel as soon as each eNB senses that the channel is free. The controller may then transmit information such as the starting time and/or the length of channel reservation to each eNB.

When reserving the channel, eNBs issue RTS/CTS commands. In one embodiment, an eNB may transmit both the RTS and the CTS commands. In another embodiment, the eNB may transmit only the CTS command and may not transmit the RTS command. Transmitting only the CTS command may reduce unnecessary transmission and overhead. In one embodiment, all participating eNBs may issue the CTS command to reserve the channel and to clear the cluster of transmissions from other systems (e.g., WiFi transmissions). All LTE eNBs may use the same access point identification (AP ID) in the RTS/CTS command so that LTE-related channel reservation can be identified. Alternatively, a field indicating LTE-related channel reservation may be added to the content of the RTS and/or the CTS commands.

As illustrated in FIG. 3(b), in one embodiment, after the controller signals the commencement of an “LTE transmission period” to the eNBs, each eNB may periodically monitor the channel. As soon as the channel is free and remains free for a period of time (i.e., t_{F} seconds), the eNB may reserve the channel until the end of the “LTE transmission period,” as indicated by the controller. Each eNB may issue, for example, an RTS/CTS command (304-306). As such, individual eNBs may reserve the channel as the channel becomes available.

However, in some cases, certain eNBs may not be permitted to transmit until all WiFi transmissions have been cleared because other eNBs may not be able to distinguish between eNB transmissions and WiFi transmissions. As such, certain embodiments enable eNB transmitting by enabling eNBs to distinguish between eNB transmissions and WiFi transmissions. According to one approach for enabling eNBs to distinguish between eNB transmissions and WiFi transmissions, eNBs may start monitoring a channel immediately upon receiving a signal from a controller that begins an LTE transmission period. Any measurement on the channel by an eNB that is monitoring the channel may be assumed to not be from other eNBs but to be from WiFi sources. When the measured signal level falls below a threshold T_{W} dBm, the eNB may then assume that the WiFi transmission has ended, and the eNB may then engage in the RTS/CTS transmission process as indicated in FIG. 3(b).

While an eNB (that is monitoring the channel) is waiting for a detected WiFi transmission to end, if the measured signal level increases by an amount A dBm, then the monitoring eNB may assume that another LTE eNB has started an LTE transmission. The monitoring eNB may then adjust its threshold to T_{W}+Δ dBm in order to account for transmissions by other eNBs and thus support simultaneous LTE transmission.

In other embodiments, additional interference coordination among LTE eNBs can also be provided. For example, in one embodiment, when a controller has received information about channel activity, the controller may allocate channels based on the Power Threshold of the channels. In another embodiment, when a first transmitting eNB senses that a frequency band/channel taken by a second eNB, for instance, has a high interference power while other bands or channels have a low interference power, the first eNB may then dynamically select a clearer channel for itself.

In addition to embodiments that reserve channels by using a centralized entity, other embodiments may perform reservation using a distributed algorithm. Several methods exist for performing channel reservation using such distributed coordination, and the coordination may be provided, at least, via sending X2 messages or sending over-the-air messages.

If coordination between eNBs is performed via sending X2 messages, a process similar to the process illustrated in FIG. 3(b) may be used, where the eNBs exchange messages as to when and as to how long to reserve the channel. For example, the length of a reservation may depend on traffic loading at each eNB. Once the length of a reservation is agreed upon, each eNB may reserve the channel as soon as the channel is free, as shown in FIG. 3(b). In one embodiment, each eNB may adjust its own reservation length depending on the transmissions of other eNBs. For example, an eNB may adjust its own reservation length such that the reservation length ends at the same time as the reservation lengths of other eNBs. As described above, each eNB may also monitor the signal level of the channel using continuous or periodic measurements in order to determine whether other LTE transmissions have started while the eNB is waiting for a WiFi transmission to end.

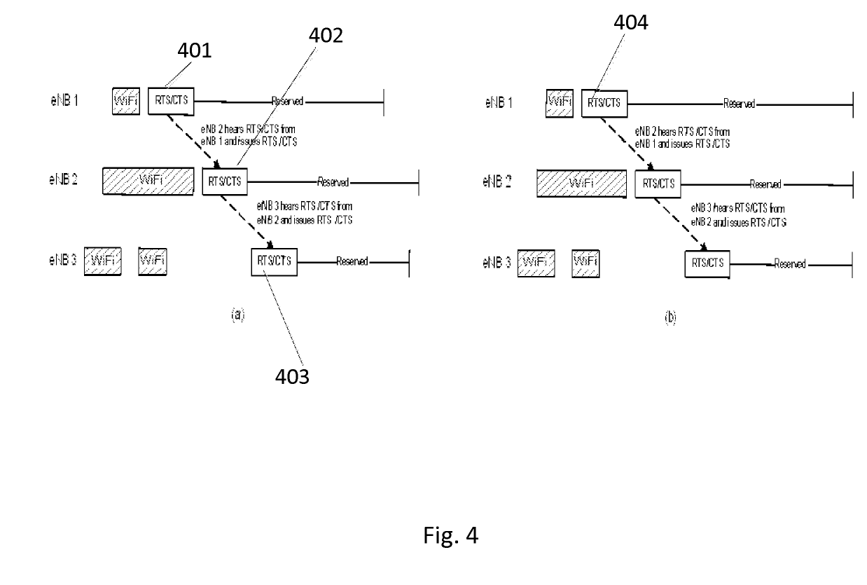

In another embodiment, a first eNB may reserve the channel on its own, and once nearby eNBs detect the RTS/CTS signal 401 from the first eNB, each of the nearby eNBs may issue their own RTS/CTS signals (402 and 403) (if the nearby eNBs have pending data to send) and thus also begin using the channel. The length of each channel reservation may be determined independently from the other channel-reservation lengths, as shown in FIG. 4(a). Alternatively, the channel reservation lengths may all end after a certain length from the first, original RTS/CTS signal 404 (if each eNB has sufficient data to send), as shown in FIG. 4(b). eNBs may determine that the observed RTS/CTS signal contain LTE-related channel reservation via the access point identification in the RTS/CTS command or through explicit LTE channel reservation field in the RTS/CTS command.

In certain embodiments, WiFi access points (APs) and terminals may not be configured to observe and follow the RTS/CTS protocol used by eNBs. With these embodiments, WiFi APs and terminals may transmit during the reserved time (as reserved by the eNBs) if the WiFi APs and terminals determine that the channel is free. Even if WiFi transmissions may occur while the channel is reserved by the eNBs, the eNBs know that the channel is reserved and can continue using the channel during the reserved time. If WiFi nodes start using the channel within the reserved time (as reserved by the eNBs), then the WiFi nodes will only detriment themselves because LTE eNBs may not observe mechanisms (such as listen-before-talk mechanisms) within the reserved time. Nevertheless, as long as LTE follows the minimum duration restrictions of the WiFi protocol, the likelihood of unexpected LTE interference to WiFi transmissions is low.

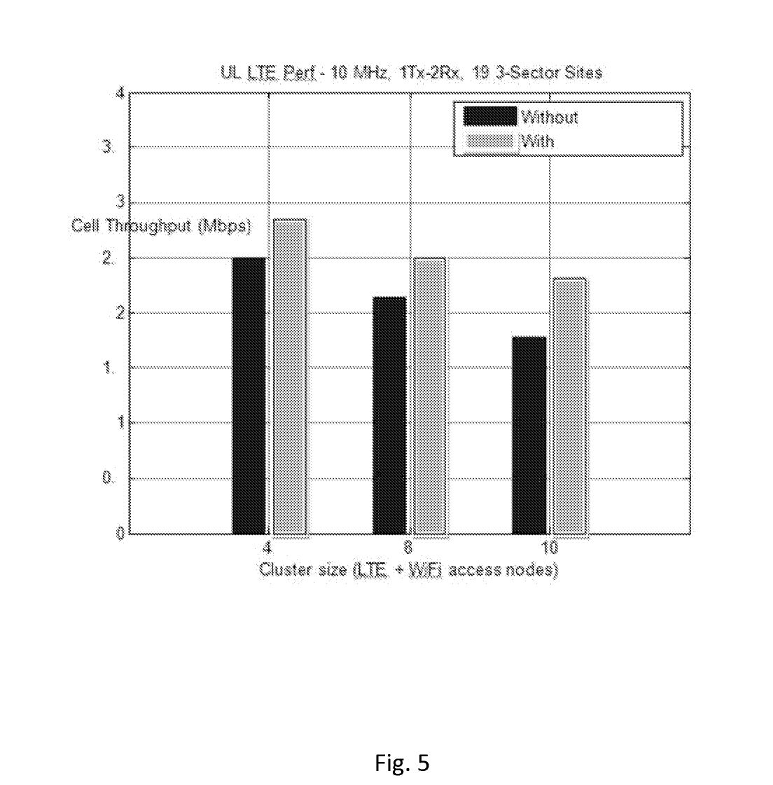

FIG. 5 illustrates performance gains which may be achieved by certain embodiments with, for example, different cluster sizes of nodes (4, 8 or 10 nodes). In FIG. 5, a cluster size of 4 means that there may be 2 eNBs and 2 WiFi APs within the cluster. As shown in FIG. 5, the reservation method according to certain embodiments (i.e., “with coordination”) may provide significant gain over clusters that may use pure listen-before-talk mechanisms (i.e., “without coordination”). As illustrated by FIG. 5, with a cluster size of 8, the reservation method may achieve approximately a 20% gain. Further, the gain may increase as the number of nodes in the cluster increases. For example, with a cluster size of 10, the gain may be approximately 30%.

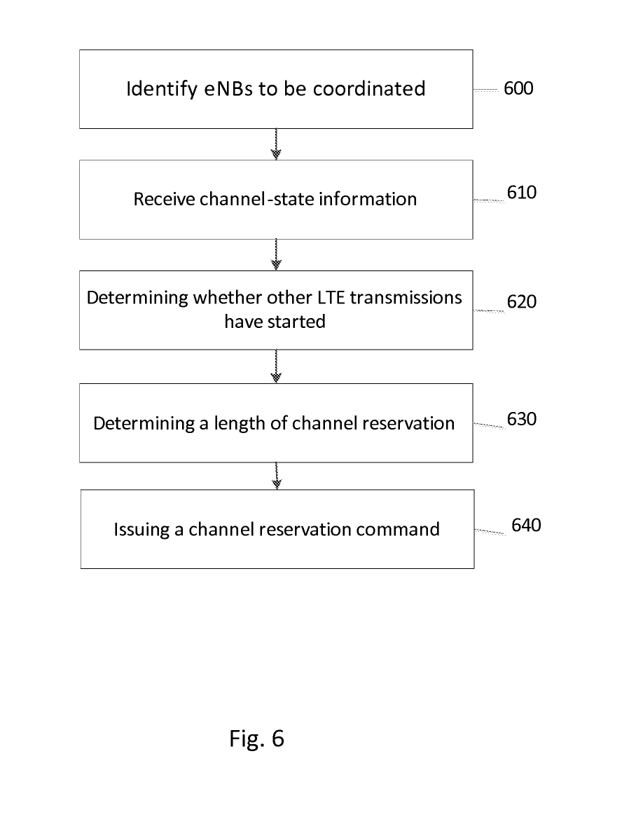

FIG. 6 illustrates a logic flow diagram of a method according to one embodiment. In an embodiment, the method illustrated in FIG. 6 comprises, at 600, identifying eNBs within a cluster that are to be coordinated. At 610, channel-state information of an unlicensed channel may be received. As previously described, in certain embodiments, channel-state information may be received by a controller. In other embodiments, channel-state information may be distributed among the eNBs themselves. At 620, as previously described, once a first eNB has reserved a channel and has begun LTE transmissions, nearby eNBs may begin their own transmissions upon detection of transmissions by the first eNB. At 630, each eNB may determine their corresponding reservation lengths for reserving the channel. At 640, each eNB may issue a corresponding channel reservation command at determined time and for a determined length, as described above.

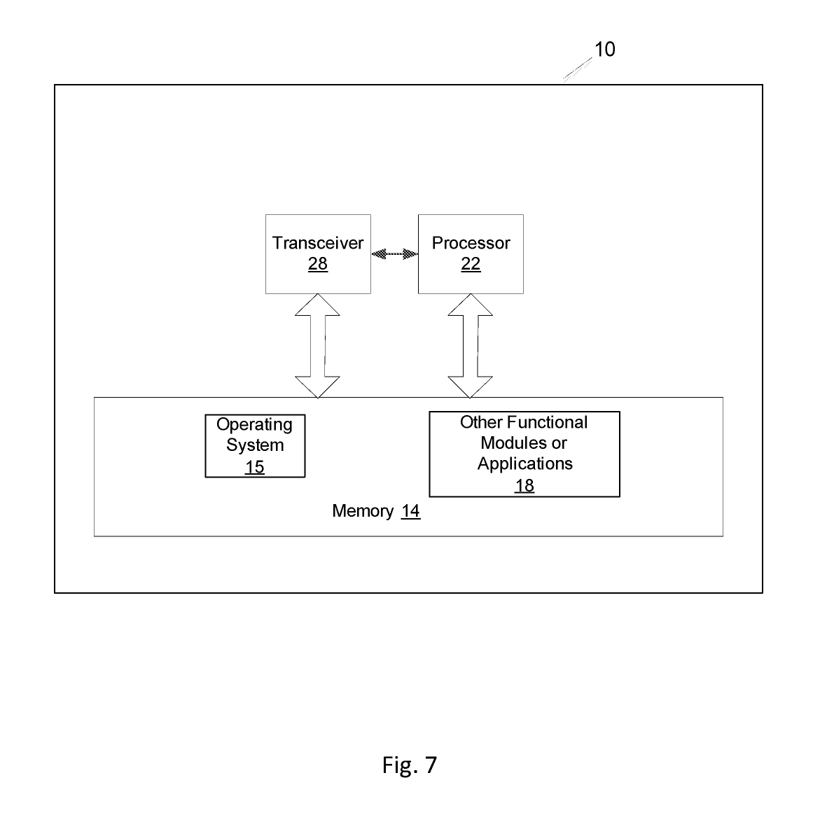

FIG. 7 illustrates an apparatus 10 according to another embodiment. In an embodiment, apparatus 10 may be a controller. In other embodiments, apparatus 10 may be a transmission node, such as an eNB.

Apparatus 10 may comprise a processor 22 for processing information and executing instructions or operations. Processor 22 may be any type of general or specific purpose processor. While a single processor 22 is shown in FIG. 7, multiple processors may be utilized according to other embodiments. Processor 22 may also comprise one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as examples.

Apparatus 10 may further comprise a memory 14, coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 may be comprised of any combination of random access memory (“RAM”), read only memory (“ROM”), static storage such as a magnetic or optical disk, or any other type of non-transitory machine or computer readable media. The instructions stored in memory 14 may comprise program instructions or computer program code that, when executed by processor 22, enable the apparatus 10 to perform tasks as described herein.

Apparatus 10 may also comprise one or more antennas (not shown) for transmitting and receiving signals and/or data to and from apparatus 10. Apparatus 10 may further comprise a transceiver 28 that modulates information on to a carrier waveform for transmission by the antenna(s) and demodulates information received via the antenna(s) for further processing by other elements of apparatus 10. In other embodiments, transceiver 28 may be capable of transmitting and receiving signals or data directly.

Processor 22 may perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 may store software modules that provide functionality when executed by processor 22. The modules may comprise an operating system 15 that provides operating system functionality for apparatus 10. The memory may also store one or more functional modules 18, such as an application or program, to provide additional functionality for apparatus 10. The components of apparatus 10 may be implemented in hardware, or as any suitable combination of hardware and software.

As mentioned above, according to one embodiment, apparatus 10 may be a controller. In this embodiment, apparatus 10 may be controlled by memory 14 and processor 22 to identify a plurality of transmitting nodes, wherein the nodes transmit corresponding transmissions by reserving at least one channel in an unlicensed band, the reserving of the at least one channel by the transmitting nodes is to be coordinated, and the plurality of transmitting nodes may be geographically clustered. Apparatus 10 may be controlled by memory 14 and processor 22 to also receive channel-state information of the at least one channel. Apparatus 10 may be controlled by memory 14 and processor 22 to also determine a subset of transmitting nodes within the plurality of transmitting nodes that will reserve the at least one channel, wherein the subset is determined based on the received channel-state information. Apparatus 10 may be controlled by memory 14 and processor 22 to also determine a start time and a length of time for reserving the at least one channel by the subset of transmitting nodes. Apparatus 10 may be controlled by memory 14 and processor 22 to also communicate the start time and the length of time to the subset of transmitting nodes.

According to another embodiment, apparatus 10 may be a transmission node. In this embodiment, apparatus 10 may be controlled by memory 14 and processor 22 to provide channel-state information of at least one channel in an unlicensed band, wherein the node transmits a corresponding transmission by reserving the at least one channel, the reserving of the at least one channel by the transmission node may be coordinated, and the transmission node may be one of a plurality of transmission nodes that are geographically clustered. Apparatus 10 may be controlled by memory 14 and processor 22 to also receive a start time and a length of time for reserving the at least one channel. Apparatus 10 may be controlled by memory 14 and processor 22 to also determine an adjusted length of time for reserving the at least one channel.

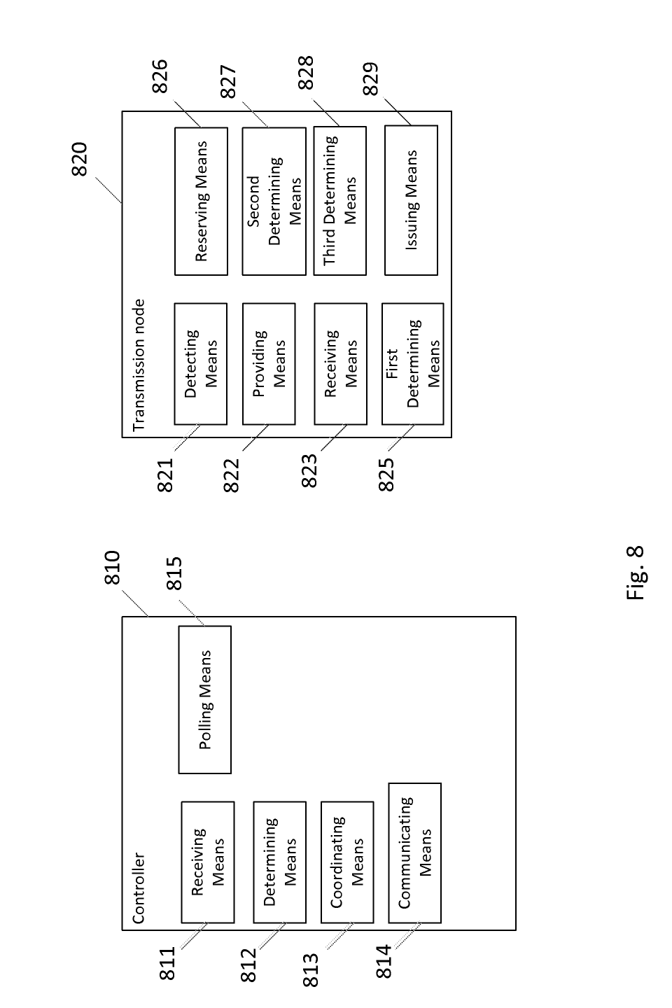

FIG. 8 illustrates a system of apparatuses according to one embodiment. The system may comprise a controller 810 (which may be a centralized controller) and a transmission node 820.

The controller 810 may comprise receiving means 811 for receiving channel-state information of at least one channel in a frequency band from at least a subset of a plurality of transmission nodes. The controller 810 may also comprise coordinating means 813 for coordinating reserving of the at least one channel for a set of transmission nodes within the plurality of transmission nodes, wherein the coordinating may be based on the received channel-state information to allow simultaneous transmission on the at least one channel by the set of transmission nodes. The controller 810 may also comprise communicating means 814 for communicating reservation information for the at least one channel to the set of transmission nodes. The controller 810 may also comprise determining means 812 for determining the set of transmission nodes for temporarily reserving the at least one channel, wherein the set may be determined based on the received channel-state information. The controller 810 may also comprise polling means 815 for polling the channel-state information of the at least one channel from the subset of the plurality of transmission nodes.

The transmission node 820 may comprise receiving means 823 for receiving reservation information for at least one channel in a frequency band from the controller 810. The transmission node 820 may also comprise first determining means 825 for determining a temporary time for reserving the at least one channel based on the received reservation information. The transmission node 820 may also comprise reserving means 826 for reserving the at least one channel for the determined temporary time. The transmission node 820 may also comprise detecting means 821 for detecting channel-state information of the at least one channel, and providing means 822 for providing the detected channel-state information to the second apparatus. The transmission node 820 may also comprise second determining means 827 for determining whether other apparatuses have started transmitting via the at least one channel, wherein, if the other apparatuses have started transmitting, the temporary time may be affected by the transmission of the other apparatuses. The transmission node 820 may also comprise third determining means 828 for determining whether the at least one channel is free from non-long-term evolution communication. The transmission node 820 may also comprise issuing means 829 for issuing a request-to-send/clear-to-send reservation command for reserving the at least one channel.

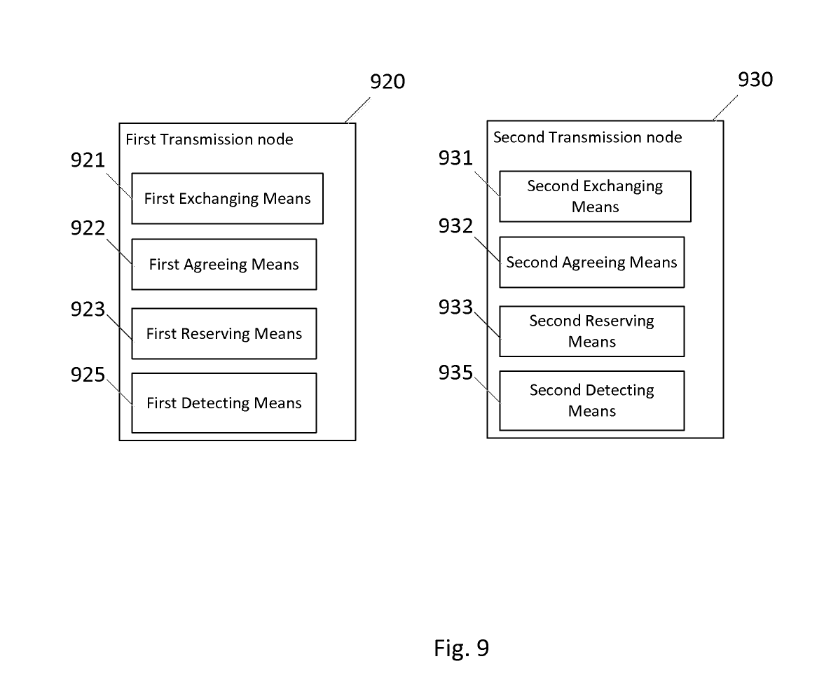

FIG. 9 illustrates another system of apparatuses according to one embodiment. The system may comprise a first transmission node 920 and a second transmission node 930.

The first transmission node 920 may comprise first exchanging means 921 for exchanging information with at least one other transmission node, wherein the information may comprise reservation related information for at least one channel in a frequency band. The first transmission node 920 may also comprise first agreeing means 922 for agreeing, with the at least one other transmission node, on a temporary reservation time for the at least one channel. The first transmission node 920 may also comprise first reserving means 923 for reserving the at least one channel for the agreed temporary reservation time. The first transmission node 920 may also comprise first detecting means 925 for detecting channel-state information of the at least one channel.

The second transmission node 930 may comprise second exchanging means 931 for exchanging information with the first transmission node 920, wherein the information may comprise reservation related information for at least one channel in a frequency band. The second transmission node 930 may also comprise second agreeing means 932 for agreeing, with the first transmission node 920, on a temporary reservation time for the at least one channel. The second transmission node 930 may also comprise second reserving means 933 for reserving the at least one channel for the agreed temporary reservation time. The second transmission node 930 may also comprise second detecting means 935 for detecting channel-state information of the at least one channel.

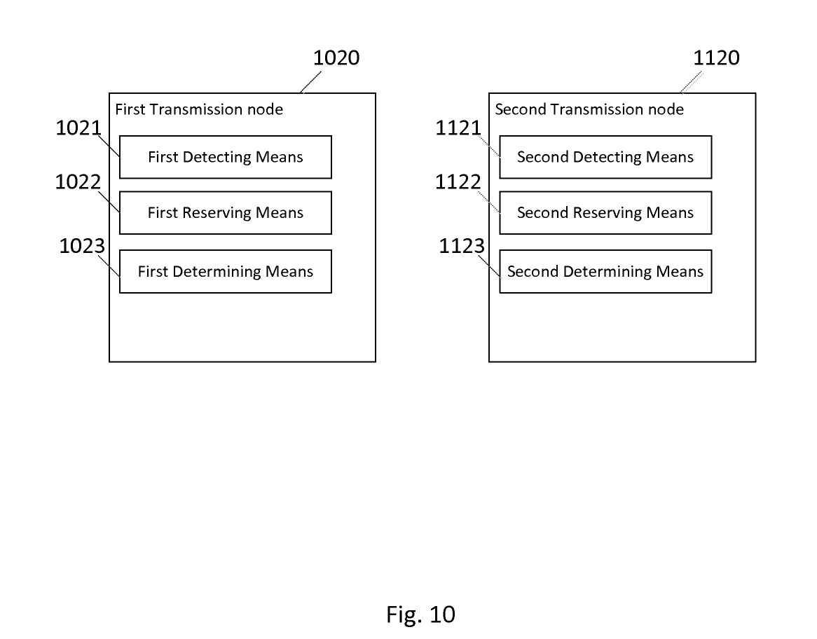

FIG. 10 illustrates another system of apparatuses according to one embodiment. The system may comprise a first transmission node 1020 and a second transmission node 1120.

The first transmission node 1020 may comprise first detecting means 1021 for detecting whether a second apparatus has issued a reservation command reserving at least one channel in a frequency band. The first transmission node 1020 may also comprise first reserving means 1022 for reserving simultaneously the at least one channel if the transmission technologies of the first transmission node 1020 and the second apparatus are similar. The first transmission node 1020 may also comprise first determining means 1023 for determining a length of time for reserving the at least one channel.

The second transmission node 1120 may comprise second detecting means 1121 for detecting whether the first transmission node 1020 has issued a reservation command reserving at least one channel in a frequency band. The second transmission node 1120 may also comprise second reserving means 1122 for reserving simultaneously the at least one channel if the transmission technologies of the second transmission node 1120 and the first transmission node 1020 are similar. The second transmission node 1120 may also comprise second determining means 1123 for determining a length of time for reserving the at least one channel.

In view of the above, certain embodiments allow LTE to coordinate transmission by LTE eNBs so that listen-before-talk mechanisms are not needed among LTE eNBs. As such, LTE system throughput can be substantially improved. The embodiments described in the context of LTE may be also used with any other type of transmission technology and are not limited to LTE. LTE was just used as an example to describe the different embodiments.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. A method, comprising:
receiving channel-state information of at least one channel in a frequency band from at least a subset of a plurality of transmission nodes;
coordinating reserving of the at least one channel for a set of transmission nodes within the plurality of transmission nodes, wherein the coordinating is based on the received channel-state information to allow simultaneous transmission which, at some point in time, occur at the same time, on the same channel by the set of transmission nodes;
communicating reservation information for the at least one channel to the set of transmission nodes.

2. The method according to claim 1, further comprising determining the set of transmission nodes for temporarily reserving the at least one channel for simultaneous transmission, wherein the set is determined based on the received channel-state information.

3. The method according to claim 1, wherein the method is performed by a controller.

4. The method according to claim 1, wherein the frequency band is an unlicensed band.

5. The method according to claim 1, wherein the reservation information comprises at least one of a start time and a length of time for reserving of the channel.

6. An apparatus, comprising:
receiving means for receiving channel-state information of at least one channel in a frequency band from at least a subset of a plurality of transmission nodes;
coordinating means for coordinating reserving of the at least one channel for a set of transmission nodes within the plurality of transmission nodes, wherein the coordinating is based on the received channel-state information to allow simultaneous transmission which, at some point in time, occur at the same time, on the same channel by the set of transmission nodes; and
communicating means for communicating reservation information for the at least one channel to the set of transmission nodes.

7. The apparatus according to claim 6, further comprising determining means for determining the set of transmission nodes for temporarily reserving the at least one channel for simultaneous transmission, wherein the set is determined based on the received channel-state information.

8. The apparatus according to claim 6, wherein the apparatus is a controller.

9. The apparatus according to claim 6, wherein the frequency band is an unlicensed band.

10. The apparatus according to claim 6, wherein the reservation information comprises at least one of a start time and a length of time for reserving of the channel.

11.-52. (canceled)

53. The method according to claim 2, wherein the method is performed by a controller.

54. The apparatus according to claim 7, wherein the apparatus is a controller.
